(19) United States
(12) Patent Application Publication
(10) Pub. No.: US 2004/0163432 A1
(43) Pub. Date: Aug. 26, 2004

(54) Electric lock for brake, clutch, and/or accelerator pedal of an automobile

(76) Inventor: Achawan Atthaprasith, Bangkok (TH)

Correspondence Address: BIRCH STEWART KOLASCH & BIRCH, PO BOX 747, FALLS CHURCH, VA, 22040-0747, US

(21) Appl. No.: 10/781,650

(22) Filed: Feb. 20, 2004

(30) Foreign Application Priority Data
Feb. 24, 2003 (TH) 080327

(51) Int. Cl. G05G 5/00; F16H 57/00

(52) U.S. Cl. 70/202

(57) ABSTRACT

An electric locking device for locking brake, clutch, and/or accelerator pedal of an automobile according to the present invention brings an electrical system to work together with a mechanism to facilitate the use and increased efficiency in prevention of theft. Users of this device no longer need to bend and pull a part of the locking device in order to lock and no longer need to use a key to unlock the master lock. This locking device will operate only when a decoder receives an instruction signal to lock and unlock from an encoder. The decoder then sends a signal to give instruction to a control circuit to send an output to control the operation of various theft prevention systems working together with the present invention; and also to send another signal to a driver circuit to drive a motor to rotate and force the locking mechanism to carry a locking member into the locking or unlocking positions. At the same time the control circuit also monitors the travel position of the mechanism or the rotation position of the motor to determine whether it is a locking or unlocking position. A signal is sent to the driver circuit to stop the rotation of the motor if it is determined that the position detected is a locking or unlocking position.

When any part of the electrical circuit used for locking and unlocking or controlling the motor fails to function, a key can be used to unlock the master lock and to free the locking mechanism including the locking member into an unlocked condition. An encoder can send a reset signal to another set of decoder installed separately to reset and disable the operation of various theft prevention systems working together with the present invention, thereby enabling the vehicle to function normally.

Moreover the motor and electrical circuit according to the present invention can be used to work with various types of locking mechanisms to lock the brake, clutch, and/or accelerator pedal of an automobile, with such locking mechanism varying according to the structure of vehicle of each type and each model.

### BACKGROUND OF INVENTION

Lock for brake, clutch, and/or accelerator pedal is a device installed in an automobile for preventing car theft. Existing lock comprises only one single mechanism. A user can lock by pulling the lock shaft or a predetermined portion to force a metal part for locking to move to lock the brake, clutch, and/or accelerator pedal so that these parts cannot function. A master lock system can engage the lock to prevent the locking metal member from being disengaged from a locked state. A user can unlock by using a specially designed key unique to an individual lock to disengage the master lock, forcing the locking metal member to disengage from the brake, clutch, and/or accelerator pedal. This type of locking mechanism is clearly very inconvenient to use because the lock must be installed beneath a car console closer to the floor with limited space to maneuver. When locking the user must bend down to pull the lock shaft or a predetermined portion for engaging the lock. When unlocking the user must also bend down to unlock the master lock with a key. This inconvenient nature of use make such type of locking device unpopular among users. The present invention proposes a locking system and locking device for locking brake, clutch, and/or accelerator pedal using electric power in order to facilitate the locking and unlocking operation and to increase the efficiency and effectiveness of theft prevention.

### OBJECT OF INVENTION

An electric lock for locking brake, clutch, and/or accelerator pedal according to the present invention employs an electrical system to control a mechanical locking or unlocking operation, in order to facilitate the operation by a user and to increase the efficiency of theft prevention over existing locking devices which operate by mechanical force only. Locking can thus be achieved without the user having to manually pull or push the lock shaft to engage the lock; and unlocking can be achieved without the user having to use a key to disengage the master lock. Moreover, locking device according to the present invention can be used in combination with other types of theft prevention system to further increase its efficiency and capacity, by introducing signals from the electrical system to the theft prevention system.

An object of the present invention is to increase the capacity and efficiency of theft prevention of locking devices for locking brake, clutch, and/or accelerator pedal of an automobile. This is achieved by combining an electrical system to the existing mechanical system, using a motor as a power source to move the mechanical system into and out of locking position. As a result, the user no longer needs to manually pull the lock shaft or a predetermined portion to engage the lock; and no longer needs to use a key to disengage the master lock. This makes the locking device easier and more convenient to use.

Another object of the present invention is to provide an enclosure over parts used for locking and unlocking operation, i. e. decoder circuit, control circuit, driver circuit, and motor using metal to prevent destruction and to protect the devices inside. In case there is a malfunction of the electrical system used to engage or disengage the lock, the user still has an alternative to use a key to disengage the master lock and free the brake, clutch, and/or accelerator pedal to function normally. In addition, a separate encoder and decoder circuit can be used to reset the various theft prevention systems used in combination with the present invention in order to allow the car to work normally.

Another object of the present invention is to enable application of an electrical system including a motor of the locking device of the present invention in controlling mechanical systems in various manners which allow locking of brake, clutch, and/or accelerator pedal of an automobile. Such mechanical systems can differ in terms of structure and operation considered suitable for each type or model of automobile.

### BRIEF DESCRIPTION OF THE DRAWINGS

FIG. 1 shows the first manner of operation of an electric lock for locking brake, clutch, and/or accelerator pedal of an automobile.

FIG. 2 shows the second manner of operation of an electric lock for locking brake, clutch, and/or accelerator pedal of an automobile.

FIG. 3 shows an electric lock for locking brake, clutch and/or accelerator pedal in a locked state.

FIG. 4 shows an electric lock for locking brake, clutch and/or accelerator pedal in an unlocked state.

FIG. 5 shows various parts of the mechanical locking system of an electric lock for locking brake, clutch and/or accelerator pedal in one embodiment of the present invention.

FIG. 6 shows an embodiment of an electric lock for locking brake, clutch and/or accelerator pedal when combining the electrical system and mechanical system shown in FIG. 5 for coordinated operation.

FIG. 7 shows a comparison of the mechanical lock system of a electric lock for locking brake, clutch and/or accelerator pedal for automobile in FIG. 5 in normal operation A to a situation in which a key is used to unlock B in case the electrical circuit controlling the locking and unlocking operation and the motor is not working.

FIG. 8 shows another embodiment of the locking mechanism according to the present invention.

FIG. 9 shows another embodiment of part(s) used for attaching the locking device to the steering wheel shaft and a combination of the master lock system with another type of locking mechanism according to the present invention.

FIG. 10 shows another embodiment of the locking mechanism according to the present invention.

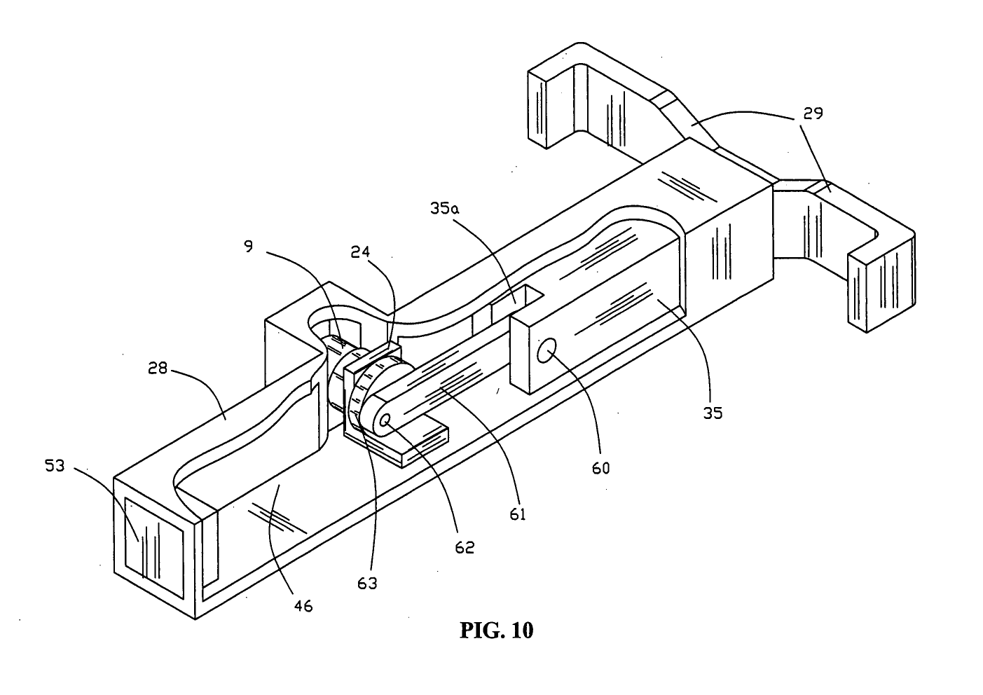

FIG. 11 shows another embodiment of the locking mechanism according to the present invention.

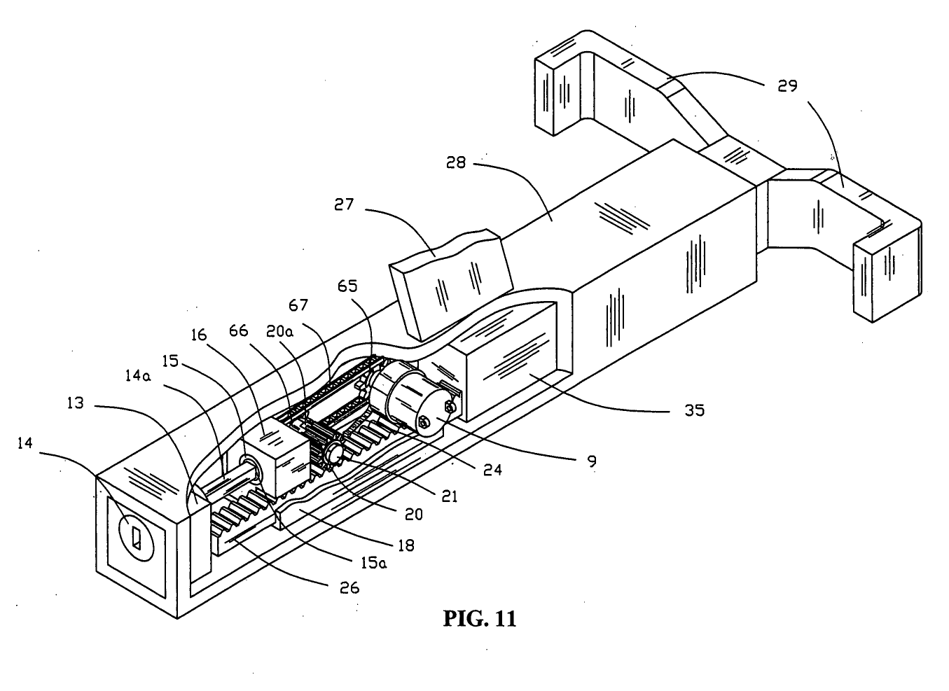

FIG. 12 shows another embodiment of the locking mechanism according to the present invention.

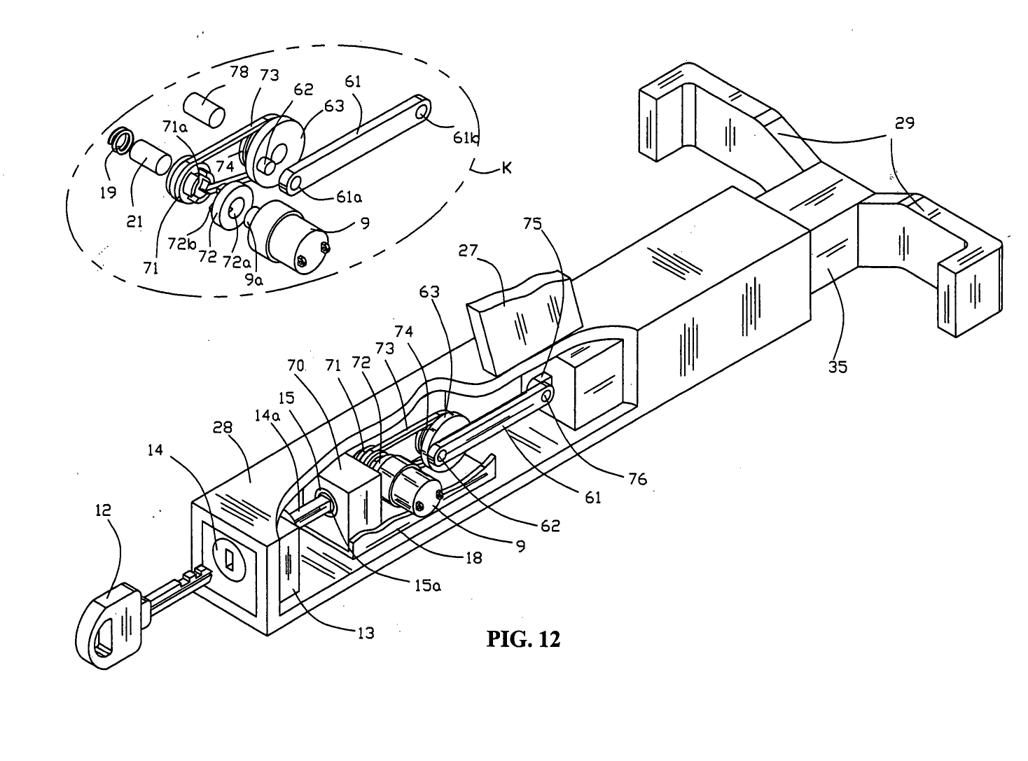

### DETAILED DESCRIPTION OF THE INVENTION

For convenience of description an electric lock for locking brake, clutch, and/or accelerator pedal of an automobile according to the present invention will be referred to as “locking device”.

The present invention proposes an application of an electrical system to control a locking and unlocking mechanism to eliminate the need to manually operate the locking mechanism as practiced in the existing work. The electrical system comprises at least an encoder 5 for encoding signals for controlling the locking and unlocking operation and then sending said signals to a decoder 6. The encoder will generate or determine a code unique to each locking device. Encoding method used can either be of a type used for smart card, radio frequency identification transponder (RFID) system, bio-matrix system (to verify fingerprints, retina, or face of a person); or other methods of encoding practicable by those skilled in the arts, using either only one system or a combination of more than one system. Transmission of coded signals to the decoder according to the present invention can be either wired or wireless, such as sending coded signals with a remote control device using optical wave or radio wave as a carrier wave.

The decoder 6 compares the coded signals received from a given encoder for correspondence before sending to a control circuit.

The control circuit 7 sends output 11 to control the operation of various theft prevention systems used in combination with the present invention and sends a control signal 40 to a driver circuit to control the operation of the motor. Another function is to monitor the travel distance of the mechanism or rotation of the motor in order to determine whether the current position of the mechanism or the motor is a position in a locking or unlocking state.

The driver circuit 8 amplifies and formats signals to a suitable form to control the motor to rotate the mechanism 10 to engage or disengage the lock.

The decoder 6, control circuit 7, and driver circuit 8 according to the present invention can alternatively be replaced partially or entirely by a micro-controller or integrated circuit specially designed.

The motor 9 is a power source to move the locking mechanism to carry the locking member 29 to lock or unlock the brake, clutch, and/or accelerator pedal. This motor may also include a gear box.

The master lock can be unlocked by a key in order to free the locking mechanism into an unlocked state when the electrical circuit controlling the locking and unlocking operation (decoder, control circuit, and driver circuit) or the motor malfunctions.

Moreover, the electrical system also includes an encoder 1 to encode signals for resetting and to send the code signals to the decoder 2 to compare the code signal to a given code for matching. If a match is detected then a signal will be sent to a theft prevention disabling circuit 3 to send an output 4 to reset and disable the theft prevention systems working together with the device of the present invention. The encoder 1, decoder 2, and theft prevention disabling circuit 3 are in a separate set of electrical system provided as a replacement of the electrical system for locking or unlocking (encoder 5, decoder 6, control circuit 7, driver circuit 8) including motor 9 in case of breakdown.

The theft prevention systems working together with the device of the present invention are theft prevention systems controlling the operations of various parts of an automobile so they cannot function normally when the locking device is in a locked state. Examples of such systems are burglar alarm system, engine start control system, car movement control system, fuel supply control system, ECU function control system, or locking systems for various parts of a car. When the locking device according to the present invention is instructed to lock, the encoder 5 will cause the control circuit 7 to send an output 11 to control the operations of such theft prevention systems. This makes the car unable to work normally. On the other hand, disengaging the lock with cause the control circuit 7 to send an output 11 to disable the operation of the theft prevention system, bringing the car back into a normal working condition.

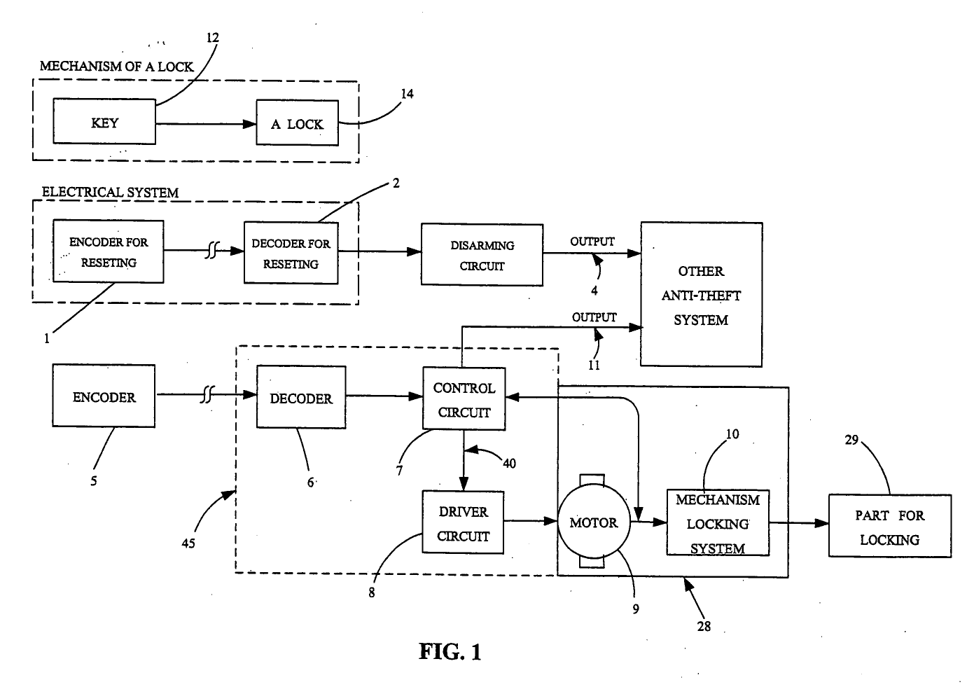

An explanation of the operation of the locking device according to the present invention will be given below with reference to FIG. 1. When the decoder 6 receives a code signal with instruction to lock or unlock from the encoder 5 it will use the code signal received to compare with a given code for matching. If a match is detected then a signal will be sent to the control circuit 7 to cause the control circuit to send an output 11 to control the operations of the various theft prevention systems. A control signal 40 is also sent to the driver circuit 8 to amplify and format signals into a suitable form to control the operation of motor 9 to rotate the mechanism 10 to engage or disengage the lock according to the code signal received. At the same time the control circuit 7 will check the travel distance and position of the mechanism or the rotated position of the motor whether the position is in locking or unlocking state of the device. If the position of the mechanism or the motor is not a locking or unlocking position, the control circuit will send a signal to the driver circuit to make the motor rotate further until a locking or unlocking position is reached. At such positions, the control circuit will send a signal to the driver circuit to make the motor stop rotating.

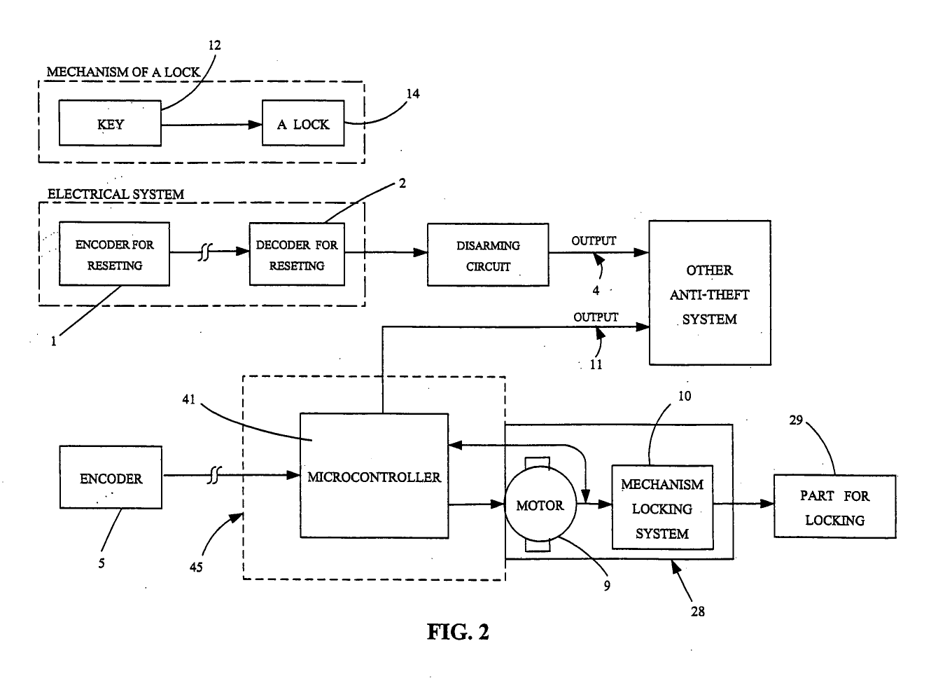

The device according to the present invention can also include a micro-controller 41 or an integrated circuit (IC) specially designed to replace the decoder 6, control circuit 7, and driver circuit 8 (FIG. 2) by comparing the code signals received from encoder 5 with a given code for matching. If a match is detected then the micro-controller or IC will carry out a processing to send an output 11 to control the various theft prevention systems used in combination with the present invention. A control signal 40 is also sent to the driver circuit to control the operation of the motor; as well as to monitor the travel distance of the locking mechanism 10 or rotation of the motor 9 to determine whether the locking mechanism or motor has moved into the locking or unlocking position. This is achieved by comparing the electrical current used in driving the motor and/or counting the revolutions of motor and/or receiving a signal from a sensor when such sensor has detected the locking or unlocking position of the locking mechanism.

According to the invention, parts of the decoder 6, control circuit 7, driver circuit 8, including parts with connection wiring from such circuits to the motor are encased in a housing 45 to prevent damages or changes in the connection of the circuits, e.g., connecting the motor to another power source directly to force the locking mechanism to disengage the locking member 29. These electrical circuits are encased before they are assembled to the motor and the locking mechanism 10 before packaging into a metal cylinder or alternatively encased in another separate housing.

The mechanism 10 is an essential part of the electric lock for locking brake, clutch, and/or accelerator pedal according to the present invention. This mechanism operates to drive a locking metal member to lock the brake, clutch, and/or accelerator pedal of an automobile so that these parts do not work normally (called “locked state”); and also operates to drive the locking metal member to unlock the brake, clutch, and/or accelerator pedal so that these parts can function normally (called “unlocked state”)

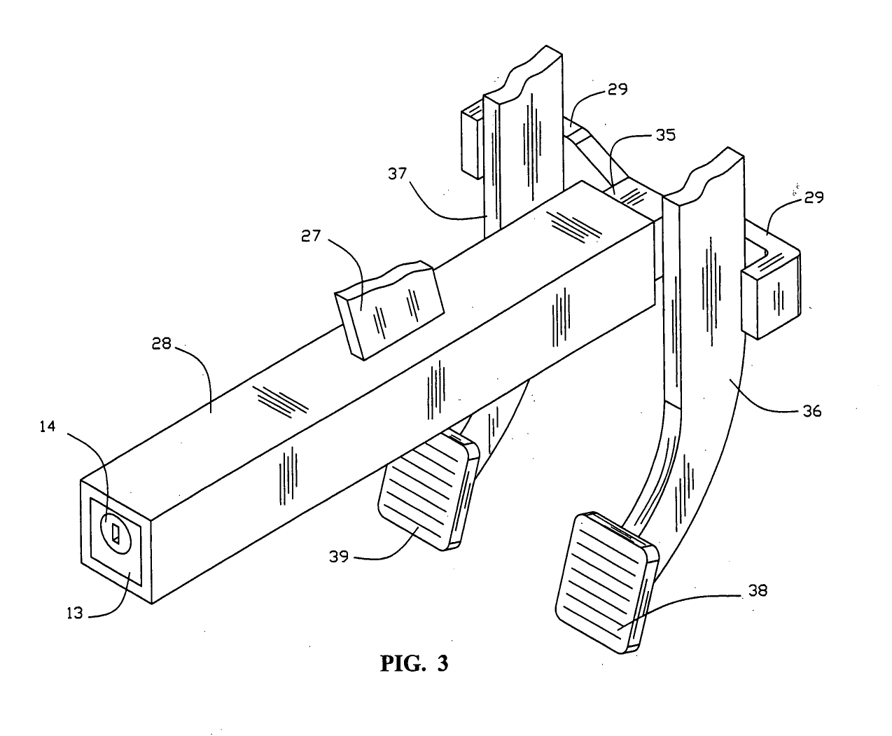

Locking of brakes, clutches, and/or accelerator pedals to disable these parts from working normally according to the present invention refers to the conditions that the locking member 29 moves to lock the brake 36, clutch 37, and/or accelerator pedal (according to FIG. 3) or a condition that the locking member 29 moves to lock the brake 36, clutch 37, and/or accelerator pedal (not shown) or a condition that the locking member 29 moves to press the accelerator pedal 38, clutch pedal 39, and/or accelerator pedal (not shown) or a condition that the locking member 29 moves to latch against the brake 36, clutch 37, and/or accelerator pedal (not shown) whereby the locking member locks the brake or clutch or accelerator pedal or extend in length and deform in the shape of locking member to fit the brake and clutch in order to effectively lock the brake and clutch to disable these parts from working simultaneously; or extend in length and deform in shape to fit the brake, clutch, and accelerator pedal to be able to lock the brake, clutch, and accelerator pedal at the same time. These operations are considered within the scope of the present invention.

The mechanism describe above has many manners of operations which can be applied to work together with the electrical system of the present invention using a motor as a power source to drive the mechanism to engage or disengage the lock. This mechanism is designed to fit the structure of automobiles in each model.

Regardless of the shape and methods of operations of this mechanism, the electrical system according to the present invention can be applied to control the motor to move the mechanism to engage the lock on the brake, clutch, and/or accelerator pedal so that these parts cannot be operated. This is considered to be within the scope and spirit of the present invention.

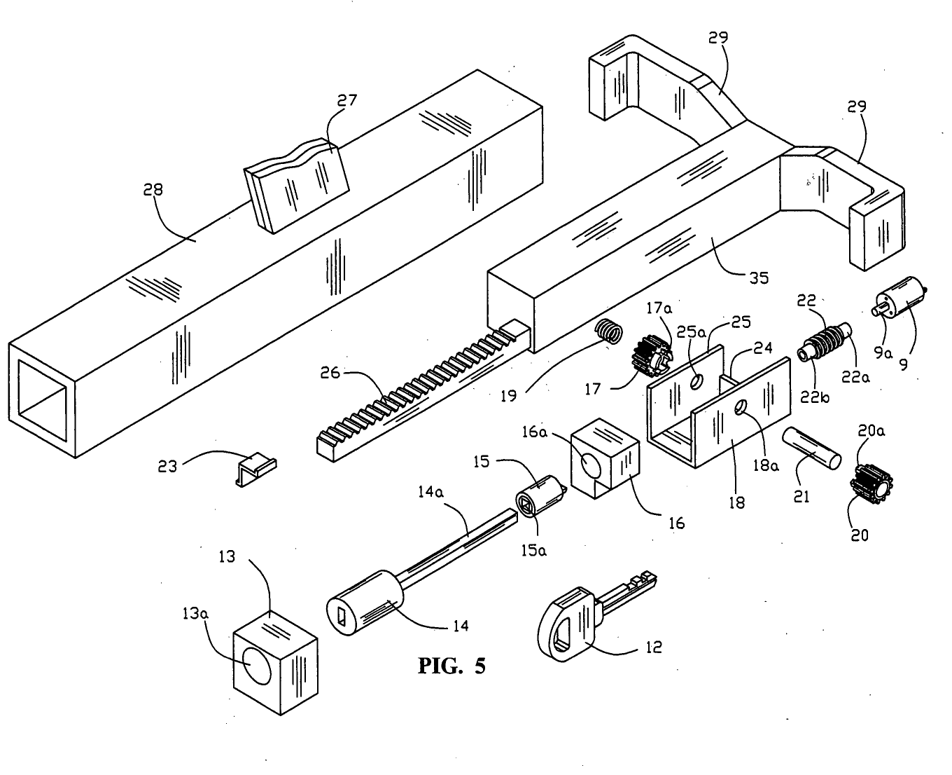

The drawings in FIG. 5 and after show an embodiment of the present invention for convenience of explanation and understanding of the principle of the present invention without limiting the invention. According to the Figure the mechanism 10 comprises the following parts:

A master lock comprising a key 12 specially designed for each locking device for unlocking the master lock 14 in order to unlock in case any part of the electrical system used for locking or unlocking and the motor 9 of the locking device fails to function properly. This master lock is mounted to a cam set 15 for assisting in the unlocking operation. The body cylinder of the master lock 14 is inserted in the master lock base 13 and a rack base 16 used to support the master lock to prevent vibration or misalignment while unlocking.

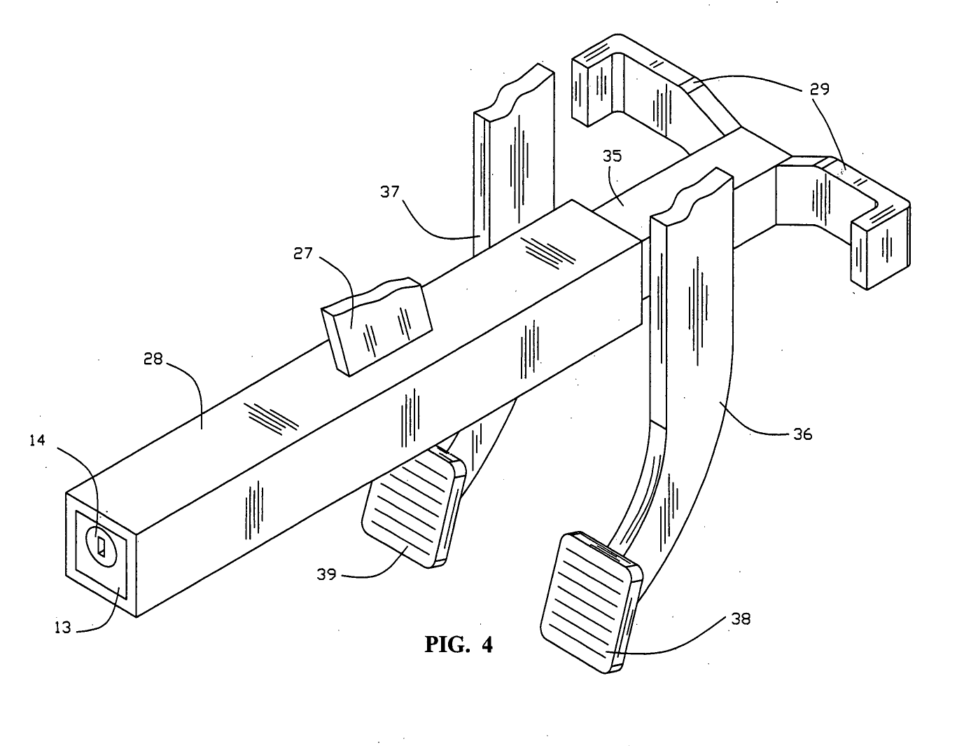

A set of gears comprising a worm gear 22 having an axle projecting from both sides. One side of the axle is inserted into the axle of the motor 9 while ted other side is inserted into a hole of the rack base 16, a rack 20 having at least one pawl projecting out for engaging with the groove of a spiral gear 17, a rack 26 and spring 19 for assembling the parts above to work together. This assembly is done by bringing the spiral gear 17, spur gear 20 and spring 19 to mount the axle 21 as shown in FIG. 4 and FIG. 5. The assembly of the rack to the spiral gear requires the pawl of the spur gear to be engaged in the groove of the spiral gear 17; and using the spring 19 to hold the spur gear and the spiral gear together while the mechanism is moved into locking and unlocking conditions. All parts installed to the axle 21 are forced to operate within the specified range determined by an axle holding plate 18 and an axle holding plate 25.

This spiral gear 17 is aligned to engage on the worm gear 22 and the spur gear 20 is positioned to engage with the rack 26. This rack may be provided with gear teeth fully or partially, depending on the distance between the car floor and the brake, clutch and/or accelerator pedal in each model of automobiles. One end of the rack 26 is attached to a metal locking member for locking the brake, clutch, and/or accelerator pedal 29 while the other end is engaged with the groove of the rack base 16. On the body of the rack is a coupler 23 to support the rack and prevent the rack from vibration or misalignment while the mechanism is moved to lock or unlock.

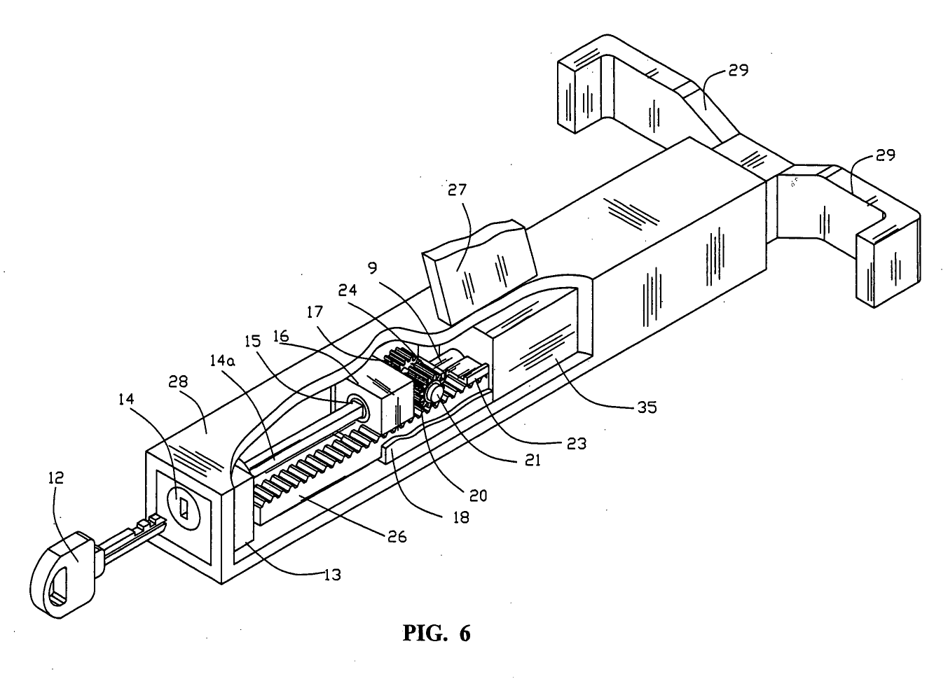

The locking mechanism mentioned above is assembled to the rotation axle 9a of the motor and then inserted into a metal cylinder 28 to protect the mechanism and device inside from damage. This encasing allows part of the moving axle 35 and the locking member 29 to protrude out of the set metal cylinder (see FIG. 6) in order to lock the brake, clutch, and/or accelerator pedal so they cannot function normally.

The locking metal member 29 of the mechanism 10 projects out of the metal cylinder 28 on the side of the metal cap 30 as seen in FIG. 3 in order to lock the brake, clutch, and/or accelerator pedal so that they cannot function normally.

In order to allow the locking device according to the present invention to be able to permanently attached inside an automobile and attachment member 27 is provided for this function. This enables the locking device according to the present invention to be able to fit with all models of automobiles. The attachment member can be designed to fit the structure of every model of automobiles. Installation besides attaching to the cylindrical casing of the steering wheel shaft can also be done by installing in an area close to the steering wheel shaft cylindrical case or near the attachment base of the brake pedal or on the automobile body (not shown). This is considered within the scope of the present invention.

An embodiment of the mechanism shown in FIG. 5 has a function to move into a locking or out of locking state. When the encoder 5 sends a code signal for initiating a locking or unlocking action to the decoder 6, the decoder will verify the code signal and if it is determined that the signal is correct it will send a signal to the control circuit 7 so that the control circuit 7 sends an output 11 to control the operation of the theft prevention system and sends a control signal 40 to the driver circuit in order to amplify and format the signal to a form suitable for controlling the operation of the motor 9 to rotate in the counterclockwise or clockwise direction based on the instruction signal received. When the motor is rotated, the worm gear 22 will rotate and follow because one side of the axle of the worm gear 22 is coupled to the axle of the motor. This makes the spiral gear 17 engaging with the worm gear and the spur gear 20 which has a pawl protruding to engage with the groove of the spiral gear 17 and coupled to the same axle rotate accordingly. The rack 26 engaging with the spur gear is then moved to carry the locking metal member 29 into a lock condition with the brake, clutch, and/or accelerator pedal of the automobile; or moved to carry the locking metal member out of the locking condition from the brake, clutch, and/or accelerator pedal of the automobile (see FIG. 5).

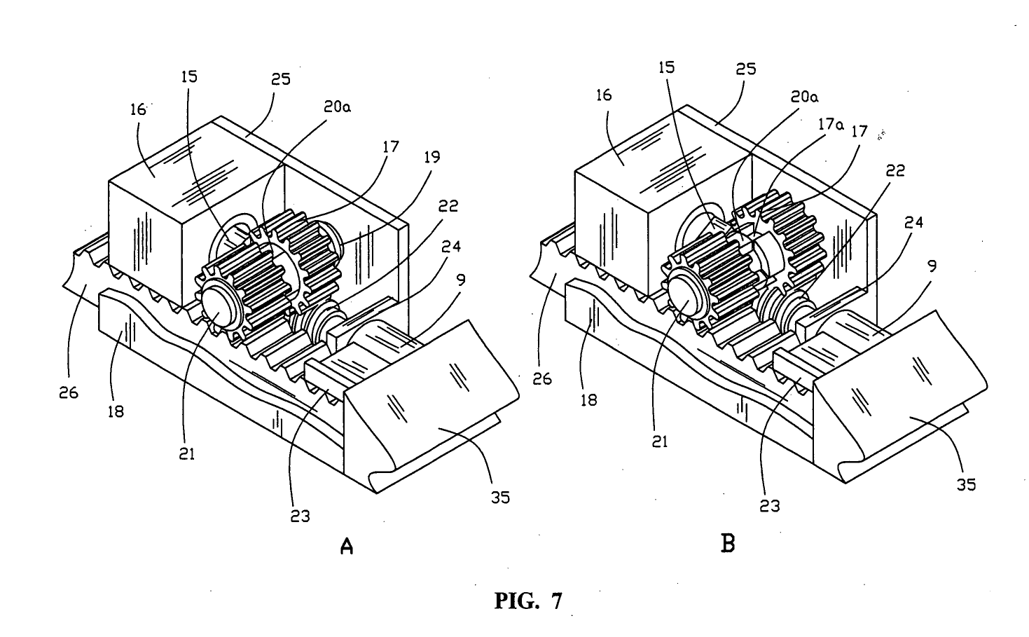

In case any part of the electrical system used for locking and unlocking malfunctions, the key 12 can be used to unlock the master lock to force the cam set 15 to push the spiral gear 17 out of engagement with the spur gear 20 as seen in FIG. 7(b). This makes the spur gear 20 and the rack 26 disengage from the spiral gear 17 engaging with the worm gear 22 and enables the operator of the locking device to push the locking metal member 29 to move out of the locking position with the brake, clutch, and/or accelerator pedal of the car. Additionally, the encoder 1 can be used to send a code signal to reset to the decoder 2 to send a signal to disable the theft prevention system 3, to send an output to reset and disable other theft prevention systems. After all these steps are carried out, the systems of the automobile will return to normal working conditions.

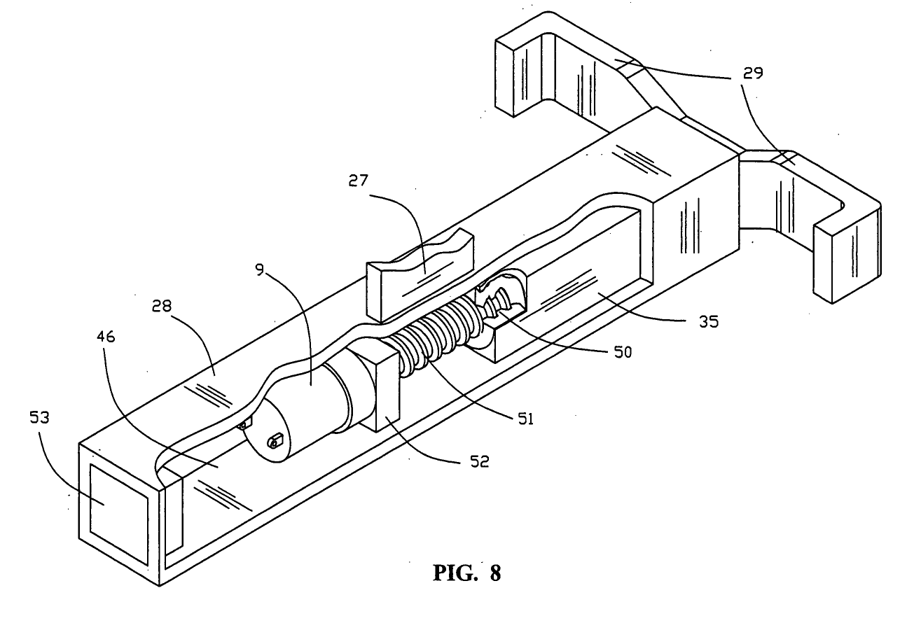

FIG. 8 and after show another embodiment of the mechanism according to the present invention to illustrate that the electrical circuit used in this invention can be applied to other mechanisms. The locking mechanism 10 shown in FIG. 8 is another embodiment of the mechanism according to the present invention comprising the following parts.

A lead screw 51 having one end with a hole for inserting a rotation axle 9a of the motor 9. This lead screw is supported to prevent vibration and misalignment by a bush 52 and the body of the lead screw is inserted into a female screw hole 50 of the moving axle 35 which is connected to the locking member 29.

When parts of the locking mechanism mentioned above are assembled to the rotation shaft 9a of the motor 9 and the electrical circuit used for controlling locking and unlocking (decoder 6, control circuit 7, and driver circuit 8), already encased in a housing is assembled in this space 46, this assembly is then put into a metal cylinder 28 and a cap 53 to protect the locking mechanism, motor, or internal circuits from damage. This protection allows certain parts of the moving axle 35 and the locking member 29 to protrude out of the metal cylinder (FIG. 8). When a motor receives a signal from the electrical circuit, it will rotate and force the lead screw to follow, making the moving axle 35 which has a female screw hole 50 inserted with that screw to move and carry the locking member 29 to lock or unlock the brake, clutch, and/or accelerator pedal.

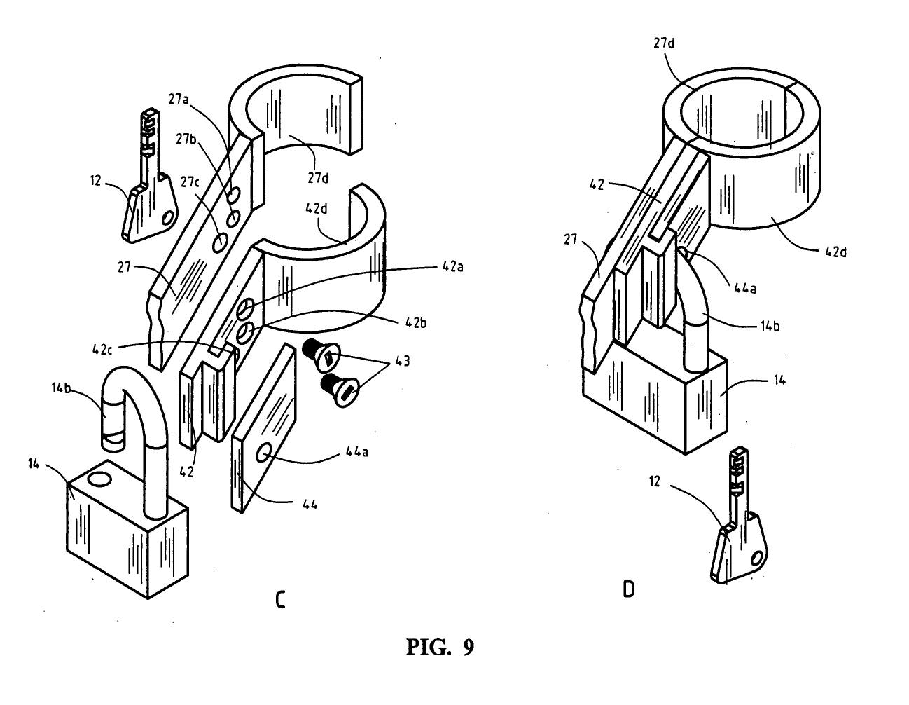

When installing the locking device according to the present invention permanently in a car (in this example, the installation is made to the encasing cylinder covering the axle of the steering wheel of a car), the attachment leg 27 attached to the metal cylinder 28 (with electrical circuit and locking mechanism assembled inside) will be assembled to the attachment member 42. The attachment leg 27 has an attachment end 27d with a curve to sit with the cylindrical casing of the steering wheel axle and conforming to the end 42d of the attachment member 42 which is curved to fit the cylindrical casing of the steering wheel axle 2. When both parts are installed to the cylindrical casing of the steering wheel axle as shown in FIG. 9d, a screw 43 is inserted into the hole 42a and 42b of an attachment member 42, and the hole 27a and hole 27b of the attachment leg 27 and then tightened up (The screw 43 is a common screw for general use or can be a permanent screw. This is considered to be within the scope of the present invention.) A screw cover plate 44 is then assembled to the attachment member 42 by aligning the hole 44a of the screw cover plate to the hole 42c of the attachment member 42. The screw cover plate will cover the screw head 43 of both screws so they cannot be unscrewed out. After that, the locking axle 14b of the master lock 14 can be inserted into the hole 44a, hole 42c, hole 27c respectively and the master lock can then be locked.

The end 27d of the attachment leg 27 can be bent to conform with the cylindrical casing of the steering wheel shaft and also can be bent to fit the attachment base of the brake pedal of the car (not shown in the figures) in order to receive the end 42d of the attachment member 42 which is bent to receive the attachment base of the brake of the car (not shown). This is considered to be within the scope of the present invention.

The electrical circuit used for locking and unlocking according to the present invention refers to the decoder 6, control circuit 7, driver circuit 8 including connections between this circuit to the motor 9. The electrical circuit also refers to the micro controller or the integrated circuit operating in place of the circuit mentioned above.

Any modifications or changes can be made by those skilled in the art without deviating from the object and scope of the present invention as defined in the claims attached.

1. Electric locking device for locking brake, clutch, or accelerator pedal of an automobile comprising:
an encoder 5, a decoder 6, a control circuit 7 for controlling the operation of the motor and controlling the operation of the theft prevention systems working together with the locking device, driver circuit 8 for amplifying and formatting signals into a suitable form to control motor operations, motor 9 which functions as a power source in moving the mechanism for locking brake, clutch, and/or accelerator pedal 10 to carry a locking member 29 into locking or unlocking condition with the brake, clutch, and/or accelerator pedal to prevent these parts from functioning normally; the said mechanism being assembled to a rotation axle of the motor and then encased in a metal cylinder 28 to protect the mechanism and internal device from damage, a master lock for unlocking in case the electrical circuit or motor fails to operate.
Characterized in that the decoder 6, control circuit 7, driver circuit 8 including connections between these circuits to the motor are encased to protect from damages or changes of connections of the circuits, these parts operating together in such a manner that when the decoder 6 receives an instruction signal to lock or unlock from the device or encoder 5, it will compare the code signal with a predetermined code for a matching and if the code signal matches the predetermined code, then a signal will be sent to the control circuit 7 to make the control circuit send an output 11 to control the operations of the theft prevention systems working together with the locking device and send a control signal 40 to a driver circuit to amplify and format signals into a suitable form to drive the motor 9 in order to rotate the locking mechanism 10 to carry a locking member 29 to move to lock the brake, clutch, and/or accelerator pedal of a vehicle so they cannot be used or moved to unlock the brake, clutch, and/or accelerator pedal of a car so they cannot be used; the control circuit also monitors the distance and position of the travel of the locking mechanism or the rotation position of the motor to determine whether it is in locking or unlocking conditions by comparing the electrical current used in driving the motor and/or counting the revolutions of the motor and/or receiving a signal from a sensor when the sensor detect the locking or unlocking position of the mechanism;
when any part of the electrical circuit or motor fails to function, a key can be used to unlock the master lock to disengage the locking mechanism and the encoder 1 can be used to send a signal to reset to the decoder 2 provided separately in order to make the decoder compare the code signal received with a predetermined code and send a signal to disable the theft prevention systems 3 for matching in order to send an output 4 to reset the theft prevention systems working together with the locking device.

2. An electric locking device for locking brake, clutch, and/or accelerator pedal of an automobile according to claim 1 capable of using a micro controller or integrated circuit specially designed to compare code signal received from the encoder 5 with a predetermined code for a matching; if a matching is detected, the micro controller or integrated circuit will carry out a processing to send an output to control the operation of the theft prevention systems working together with the locking device and send a control signal to drive the motor to rotate and move the locking mechanism to carry the locking member 29 to move to lock the brake, clutch, and/or accelerator pedal instead of using the decoder 6, control circuit 7, and driver circuit 8.

3. An electric locking device for locking brake, clutch, and/or accelerator pedal of an automobile according to claim 1, wherein the transmission of the code signal to instruct the locking or unlocking from the encoder 5 to the decoder 6 is a wired or wireless transmission of signal.

4. An electric locking device for locking brake, clutch, and/or accelerator pedal of an automobile according to claim 1, wherein the transmission of code signal for resetting from the encoder 1 to a separate set of decoder 2 is a wired or wireless transmission of signals.

5. An electric locking device for locking brake, clutch, and/or accelerator pedal of an automobile according to claim 1, wherein the electric locking device is permanently attached inside an automobile by attaching to the cylindrical casing of the steering wheel axle, or in the proximity of the cylindrical casing of the steering wheel, or at the attachment base of the brake pedal or the automobile body.

6. An electric locking device for locking brake, clutch, and/or accelerator pedal of an automobile according to claim 1, wherein the locking mechanism for locking brake, clutch, and/or accelerator pedal of an automobile 10 comprises at least:
A set of master lock including a key 12 specifically designed for each individual locking device for unlocking the master lock 14 in case any part of the electrical circuit used for locking or unlocking (decoder 6, control circuit 7, driver circuit 8) or motor 9 fails to function, the master lock having an axle 14a protruding to engage with the groove 15a of a cam set 15 for assisting in the unlocking operation, the body of the master lock 14 being inserted into the hole 13a of the master lock base 13 and the body of the cam set 15 being inserted into a hole 16a of the rack base 16 to support and prevent vibration and misalignment while using the key to unlock the master lock;
a gear set comprising a worm gear 22 having an axle 22a and 22b projecting from both sides, the axle 22a being mounted to the rotation axle 9a of the motor 9 and the axle 22b being mounted to the hole of the rack base 16, a spur gear 20 having at least 1 pawl 20a projecting out for engaging with a groove 17a of the spiral gear 17, a rack 26 connected to a moving axle 35 having one end of the moving axle connected to the locking member 29 and spring 19 wherein all the parts are assembled to work in coordination such that the spiral gear 17, spur gear 20 are mounted to the axle 21 using a pawl 20a of the spur gear to engage in the groove 17a of the spiral gear 17 then bringing the spring 19 to engage with the axle to retain the spur gear and the spiral gear from separating from each other while the motor rotates to move the locking mechanism to carry the locking member 29 into and out of locking condition.

7. An electric locking device for locking brake, clutch, and/or accelerator pedal of an automobile according to claim 1, wherein the mechanism for locking brake, clutch, and/or accelerator pedal 10 comprises at least:
a master lock 14 and a lead screw 51 with a hole on one end for insertion of the rotation axle 9a of the motor 9, the lead screw being supported to prevent vibration and misalignment with a bush 52 and the body of the lead screw being inserted into a female screw hole 50 of the moving axle 35 which is connected to the locking member 29.
a metal cylinder 28 attached to an attachment leg 27 provided for installing the locking device permanently inside an automobile, one end 27d of the attachment leg 27 being curved to fit the shape of the cylindrical casing of the steering wheel axle and also curved to receive the end 42d of the attachment member 42 which is curved to conform with the shape of the cylindrical casing of the steering wheel axle; both parts being installed to the cylindrical casing of the steering wheel before inserting a screw 43 through the hole 42a and hole 42b of the attachment member 42 and the hole 27a and hole 27b of the attachment leg 27 then tightening the screw and bringing a screw cover plate 44 to assemble with the attachment 42 with the hole 44a of the screw cover plate aligned to the hole 42c of the attachment member 42 to make the screw cover plate cover both screws 43 so they cannot be unscrewed, then bringing the locking shaft 14b of the master lock 14 to insert into the holes 44a, 42c and 27c respectively to lock the master lock.

8. An electric locking device for locking brake, clutch, and/or accelerator pedal of an automobile according to claim 7, wherein the end 27d of the attachment leg 27 is bent to conform with the attachment base of the accelerator pedal and to receive the end 42d of the attachment member 42 which is also bent to conform with the attachment base of the accelerator pedal.

9. An electric locking device for locking brake, clutch, and/or accelerator pedal of an automobile according to claim 1, wherein the locking mechanism 10 comprises at least:
a cam rotation disc set 63 having a hole for inserting the rotation axle 9a of the motor 9 with the body of the cam rotation disc set having an axle 62 projecting out for coupling with a swing axle 61 as shown, the swing axle having one end provided with a hole to insert a latch 60 for attachment to the moving axle 35 in the area of the groove 35a.

10. An electric locking device for locking brake, clutch, and/or accelerator pedal of an automobile according to claim 1, wherein the locking mechanism 10 comprises at least:
a sprocket 65 mounted to the rotation axle 9a of the motor 9 attached to a motor attachment plate 24, a chain 67 for engaging with the sprocket 65, and a sprocket 66 having at least one groove for engaging with a pawl 20a of the spur gear 20 mounted to the axle 21, the sprocket 66 and spur gear 20 being fixed together while the motor 9 is rotating by the spring 19, a rack 26 connected to the moving axle 35 and having one end of the moving axle connected to the locking member 29.

11. An electric locking device for locking brake, clutch, and/or accelerator pedal of an automobile according to claim 1, wherein the locking mechanism 10 comprises at least:
a connector 72 having a hole 72a for inserting the rotation axle 9a of the motor 9 and having at least one pawl 72b for engaging with the groove 71a of a pulley 71, the connector 72 and the pulley 71 (pulley 71 mounted to the axle 21) being assembled before using a spring 19 to engage with an axle to retain the pulley from moving away from the connector 72; the pulley 71 and pulley 74 being mounted with a belt to assist in driving pulley 74 and the cam rotation disc set 63 mounted to the axle 78 to rotate and force the swing axle 61 to pull or push the moving axle 35 to carry the locking member 29 into or out of locking condition.

12. An electric device for locking brake, clutch, and/or accelerator pedal of an automobile according to claim 1, wherein the electrical circuit for controlling the locking and unlocking operation of the motor can be applied to control the operation of the locking mechanism driven by a motor in order to force the locking mechanism to move and carry the moving axle 35 and the locking member 29 to lock the brake, clutch, and/or accelerator pedal of an automobile out of operation.
